(19) United States
(12) Patent Application Publication
(10) Pub. No.: US 2009/0227305 A1
(43) Pub. Date: Sep. 10, 2009

(54) Terminology data-mining method, in particular for assistance in advertising creation

(76) Inventor: Roland Moreno, Paris (FR)

Correspondence Address: JACOBSON HOLMAN PLLC, 400 SEVENTH STREET N.W., SUITE 600, WASHINGTON, DC, 20004, US

(21) Appl. No.: 12/073,561

(22) Filed: Mar. 6, 2008

(51) Int. Cl. A63F 13/12; A63F 9/24

(52) U.S. Cl. 463/9; 463/42; 463/43; 707/100

(57) ABSTRACT

The invention implements an on-line game in which a population of players is connected to an on-line game site. From a starting word submitted by the site, the players search for additional words that, when combined with the starting word, maximize the number of occurrences of the combination of words when said combination is submitted to a search engine. The game is implemented by: i) introducing as the head word the particular word for which advertising designers seek to test the impact; and ii) using the results of the game, i.e. the additional words found and submitted to the site by the players, as a result for evaluating the impact of the head word.

### FIELD OF THE INVENTION

The invention relates to a terminology data-mining method, in particular for assistance in advertising creation.

The idea consists in particular in assisting creative staff, i.e. the designers in charge of preparing an advertising campaign, when they are hesitating about the vocabulary to be used for such and such a message or slogan, or on the words that should be emphasized in the message, or on the contrary the words that should be avoided. Nevertheless, it should be observed that this particular example is not limiting on the invention, and it will readily be understood that the invention can be applied in numerous situations where there is a need to evaluate the pertinence of certain words and of their impact on a target population.

### DESCRIPTION OF RELATED ART

Until now, the techniques used for this purpose rely on polling, generally by telephone, carried out on a sample population that is representative of the intended target population.

Polling begins by selecting or recruiting individual people to make up the sample. Then questions are put to them, words are suggested to them, and they are asked to give their reactions. The pollsters note the replies, and then analyze them in more or less automatic manner.

That technique runs well and is effective, but it is nevertheless extremely expensive, since it involves very high personnel costs because of the need to recruit pollsters and a population to be polled, and to have a telephone platform.

It is also lengthy to implement prior to obtaining results because of the time needed to train the pollsters, to make the telephone calls, to collect and process the results, etc.

In contrast, the designers of an advertising campaign would like to be able to obtain, practically in “real time”, a response about the pertinence of such and such a word for use in an advertising message, ideally with a feedback time of no more than a few minutes, so as to make it possible during a given “brainstorming” meeting, either to press on with a proposal or on the contrary to revise it.

Cost is another important factor preventing staff from making numerous proposals during the initial stage of searching for concepts.

One of the objects of the present invention is to provide a data-mining method adapted to such a use, that can be implemented automatically and without significant extra cost, using a methodology that takes advantage of the speed and the power of the search engines available on the Internet.

Another object of the invention is to propose such a method that does not require a specific population of people for polling to be brought together, as is necessary for the “representative sample” of conventional polls, thereby saving on the very large costs involved in recruiting and polling that population.

Another object of the invention is to propose such a method that provides a response that is practically instantaneous, typically requiring only a few minutes, so as to make it possible to provide genuine assistance in the advertising creation processes, practically in real time, rather than merely validating a proposal, a posteriori.

### SUMMARY OF THE INVENTION

The starting point of the invention lies in the observation that collateral benefits result from using a game of the kind described for example in copending patent application U.S. Ser. No. 11/598,229 of Nov. 13, 2006 (Computer-implemented game based on combinations of words) in the name of Moreno, the disclosure of which is incorporated herein by reference.

In that game, a population of players is connected to an on-line game site. On the basis of a starting word submitted by the site, the players look for additional words that, when combined with the starting word, maximize the number of occurrences of the word combination (starting word plus additional word) when the combination is submitted to a search engine coupled to the game site.

The specific idea of the present invention consists in implementing such a game by: i) introducing as a starting word the particular word for which the advertising designers seek to test the impact (this word is referred to below as the “head word”); and ii) making use of the results of the game, i.e. the additional words found and submitted to the site by the players (referred to below as “candidate words”) as the results of an evaluation of the impact of the head word.

More precisely, the method of the invention is implemented between a data-mining operator, an on-line game site operator, a search engine coupled to the game site, and a population of web-user players connected to the game site by respective terminals. The method comprises the following steps:

a) the data-mining operator: selecting a head word and submitting the head word to the game site operator;

b) the game site operator: implementing a game session comprising the following steps:
b1) the game site: presenting the head word to the player;
b2) the players: subjectively determining candidate words that present semantic proximity relative to the head word; and
b3) the game site:
   collecting the candidate words;
   submitting to the search engine a corresponding series of requests containing the head word associated with respective ones of the candidate words; and
   receiving in return, for each of the requests, a numerical score representative of the number of occurrences of each head word and candidate word pair in a set of web pages indexed by the search engine; and

c) the data-mining operator: setting up a database from the collected candidate words and their respective numerical scores.

According to various subsidiary characteristics that are advantageous:
in step c), provision is made for setting up a list of words from the collected candidate words, said list being ordered as a function of the respective numerical scores associated with the candidate words;
in step b), provision is made for presenting a personal questionnaire to the players for collecting profile data; and in step c), provision is made for including, in the database, profile data as collected in this way;
in step c), provision is made for breaking down the words statistically as a function of said profile data; and
the data-mining operator is specifically the game site operator.

### DETAILED DESCRIPTION OF THE INVENTION

As mentioned above, the invention relies on the ability of search engines—such as Google (trademark registered by Google Inc.) or Exalead (trademark registered by Exalead SA)—to index the contents of several billion pages that are accessible for consultation on all kinds of Internet site. Such search engines are used by sending them a request containing a word or a “phrase”, i.e. a combination or string of words. The engine responds to the request within a fraction of a second by supplying not only a list of references to pertinent Internet sites, but also a numerical result (referred to below as a “score” or a “numerical score”) representative of the number of occurrences (“hits”) of pages that contain the word (or the words of the phrase) from amongst all of the pages indexed by the search engine. With a phrase combining two (or more) words, the numerical score depends on the greater or smaller semantic proximity of the words in the combination submitted to the engine.

This numerical score is information of very great value, and the invention takes advantage thereof in the manner set out below.

The present invention makes use of the game idea set out in above-mentioned patent application U.S. Ser. No. 11/598,229, that consists, after selecting a first word (the “head word”), in asking players to find and submit to the game site another word (a “candidate word”), which, when associated with the head word, produces the highest possible score.

Players who have produced the words that are the best-graded by the game site win points which can subsequently be converted into gifts, purchase vouchers, cash, etc.

This latter aspect, which is set out in detail in above-mentioned application '229, is not in itself essential in the context of the present invention, except insofar as the hope of winnings makes it possible at practically any time to amass a very large number of players, typically several thousand, or even tens or hundreds or thousands of players.

The population of players that it is possible to attract will be that much bigger when the hope of winning is high, in particular: i) if the number of winners is large (i.e. many players can win, even if only small sums); and ii) when participating in the game does not require the players to stake any money (such that a player who does not win nevertheless ends up by not losing anything, insofar as that player has not placed any bet).

These aspects of game organization, distributing prizes, and financing the game site by a technique that enables increasing numbers of players to be drawn thereto are described in detail in the following patent applications: U.S. Ser. No. 11/802,774 of May 24, 2007; and U.S. Ser. No. 11/907,814 of Oct. 17, 2007, claiming priority from the preceding application, both in the name of Moreno, and the disclosures of which are incorporated herein by reference. Those applications describe in particular how to develop the activity of an Internet site by a “virtuous circle” where an increase in traffic makes it possible to increase advertising revenues, and thus to increase the endowment that can be offered to players, and so on.

Instead of using as the starting words a word drawn randomly from a lexographic corpus by the server site, for example, or a word proposed by a player, the particular feature of the present invention consists rather in introducing as the starting word a particular term for which an advertising designer seeks to evaluate the impact.

By way of example, suppose that an advertising campaign is being prepared for a cosmetic, then it is possible to image that the designers in charge of the campaign might hesitate over the vocabulary to use in the message and the word(s) that it would be appropriate to emphasizes most particularly in the message (or on the contrary avoid).

The word in question, e.g. “vacation” is then subjected to the data-mining operator who transmits it to the game site operator (where both operators might well be the same), who then introduces the word in question as a head word in a round of the on-line game.

The word is then submitted to the population of players connected at that time to the game site, i.e. to several tens or hundreds of thousands of people. Players respond by submitting candidate words to the site, each candidate word depending strongly on the character and the mind of the player, i.e. reflecting to a greater or lesser extent the player's personality or even “opinion”, given the projective side of choosing the candidate word.

By taking “vacation” as the head word, it is thus possible to observe the score—and above the relative score—of other words such as “sea”, “mountain”, “travel”, “photo”, etc. The table below gives an example of a list of candidate words ordered as a function of their scores when combined with “vacation” (the score for “vacation” on its own being normalized as 1,000,000):

| Word (s) | Score |
|---|---|
| vacation | 1,000,000 |
| photo | 273,300 |
| travel | 258,600 |
| sea | 197,000 |
| ski | 116,800 |
| mountain | 91,000 |
| school | 90,600 |
| etc. | . . . |

Such a result can typically be obtained in 90 seconds or at most a few minutes, thus making it possible for the sponsor to obtain feedback in real time, which has previously not been possible with standard polling techniques.

The invention also benefits from an advantageous feature of the game described in above-mentioned application U.S. Ser. No. 11/598,229, where, in exchange for being free (no bets placed by players), and above all because the game brings genuine prizes of monetary value to a winner, the players are invited on subscribing to the site to fill in a simplified questionnaire serving to collect personal profile data such as: man or woman, age, socioprofessional category, place of residence (city/suburb/rural), family situation, etc.

This profile data can be used to break down the results obtained by the method of the invention, e.g. by presenting several lists of words: by age group, gender, location, etc.

The fact that the population of players is not necessarily identical to the consumers being targeted by the advertisers is compensated by applying appropriate weighting, which is made possible because of the very large number of participants. For example, if it is possible to attract 100,000 players simultaneously, it is possible to apply appropriate statistical weighting to such a population, which cannot be done with telephone polling techniques where it is necessary to begin by constituting an a priori sample of people to be polled, usually having a size of about 1,000 people. The prior step of setting up a representative of sample of people to poll (the “quota method”, etc.), can thus be completely omitted in the context of the invention, because it is possible to have a very large number of players available, typically several hundred times greater than the sample of people to be questioned in a telephone poll.

In general, the ability to have not a sample of about 1,000 people as is usual in conventional polling techniques, but rather a sample of several hundreds of thousands or even millions of people, considerably strengthens the credibility of the results obtained.

Furthermore, and above all, the speed with which results are obtained that is characteristic of the method of the invention—typically less than 2 minutes between the “creative” staff formulating the question and the numerical result being returned to the advertising agency—constitutes a considerable advantage in the work done by advertisers.

1. A method of terminology data-mining, in particular for assistance in creating advertising, making it possible to produce a series of words and to evaluate the semantic distances thereof with a given head word, the method being implemented between:
a data-mining operator;
an on-line game site operator;
a search engine coupled to the game site; and
a population of web-user players connected to the game site via respective terminals;
the method comprising the following steps:
a) the data-mining operator: selecting a head word and submitting the head word to the game site operator;
b) the game site operator: implementing a game session comprising the following steps:
b1) the game site: presenting the head word to the player;
b2) the players: subjectively determining candidate words that present semantic proximity relative to the head word; and
b3) the game site:
collecting the candidate words;
submitting to the search engine a corresponding series of requests containing the head word associated with respective ones of the candidate words; and
receiving in return, for each of the requests, a numerical score representative of the number of occurrences of each head word and candidate word pair in a set of web pages indexed by the search engine; and
c) the data-mining operator: setting up a database from the collected candidate words and their respective numerical scores.

2. The data-mining method of claim 1, also comprising:
in step c): setting up a list of words from the collected candidate words, said list being ordered as a function of the respective numerical scores associated with the candidate words.

3. The data-mining method of claim 1, also comprising:
in step b): presenting a personal questionnaire to the players for collecting profile data; and
in step c): including, in the database, profile data as collected in this way.

4. The data-mining method of claim 3, also comprising:
in step c): breaking down the words statistically as a function of said profile data.

5. The data-mining method of claim 1, in which the data-mining operator is the game site operator.
